(19) United States
(12) Patent Application Publication
(10) Pub. No.: US 2023/0063273 A1
(43) Pub. Date: Mar. 2, 2023

(54) DATA TRANSMISSION SYSTEM ACROSS PLATFORMS AND METHOD OF DATA TRANSMISSION

(71) Applicant: Fulian Precision Electronics (Tianjin) Co., LTD., Tianjin (CN)

(72) Inventors: CHUANG-WEI TSENG, New Taipei (TW); YU-CHING CHIEN, New Taipei (TW); HONG-YI ZENG, Taoyuan (TW)

(21) Appl. No.: 17/725,783

(22) Filed: Apr. 21, 2022

(30) Foreign Application Priority Data
Aug. 24, 2021 (CN) 202110977350.3

(51) Int. Cl. G06F 13/36; G06F 13/38; G06F 13/40

(52) U.S. Cl. CPC G06F 13/36; G06F 13/385; G06F 13/409; G06F 13/4068

(57) ABSTRACT

A data transmission method stores target data from an initial storage area of an initial platform to an initial temporary storage area of the initial platform in response to a first user operation. The target data is uploaded to a cloud platform. The cloud platform stores the target data. A target platform downloads the target data from the cloud platform to a second designated location of the target platform in response to a second user operation. The initial platform stores the target data from the initial temporary storage area to a third designated location of the initial platform in response to a third user operation. The method improves the efficiency of data transmission between different platforms.

### FIELD

The subject matter herein generally relates to data transmission, specifically a data transmission system and method.

### BACKGROUND

With the development of technology, platforms have become more numerous and more diversified, and data transmission between different platforms has become more difficult. In a current method, a receiver device is preset, data is selected from different platforms, and the data is transmitted to the receiver device and then to another platform, this method is inefficient.

### BRIEF DESCRIPTION OF THE DRAWINGS

In order to more clearly describe the technical solutions in the embodiments of the present disclosure or the prior art, the following will briefly introduce the drawings that need to be used in the description of the embodiments or the prior art. Obviously, the drawings in the following description are only examples. For those of ordinary skill in the art, other drawings can be obtained according to the provided drawings without creative work.

FIG. 1 is a block diagram of a data transmission system in one embodiment of the present disclosure.

FIG. 2 is a block diagram of an original platform in one embodiment of the present disclosure.

FIG. 3 is a block diagram of a mouse in one embodiment of the present application.

FIG. 4 shows a wired connection between a mouse and an external display device in one embodiment of the present disclosure.

FIG. 5 shows a wireless connection between a mouse and an external display device in one embodiment of the present disclosure.

FIG. 6 is a block diagram of a target platform in one embodiment of the present disclosure.

FIG. 7 is a flowchart of the data transmission method in one embodiment of the present disclosure.

### DETAILED DESCRIPTION

For clarity, of illustration of objectives, features and advantages of the present disclosure, the drawings combined with the detailed description illustrate the embodiments of the present disclosure hereinafter. It is noted that embodiments of the present disclosure and features of the embodiments can be combined, when there is no conflict.

Various details are described in the following descriptions for better understanding of the present disclosure. However, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments, and are not intended to limit the present disclosure.

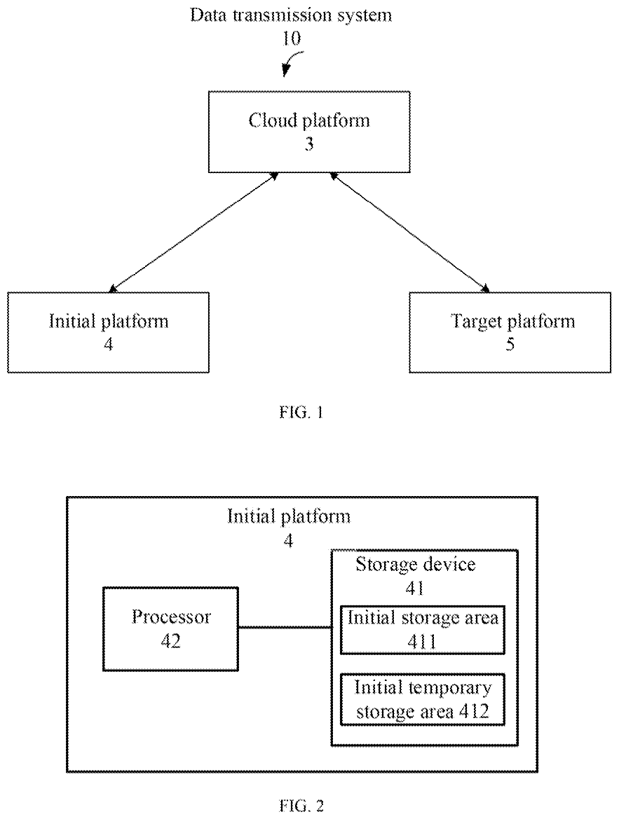

FIG. 1 is a block diagram of a data transmission system (data transmission system 10) in one embodiment of the present disclosure. The data transmission system 10 includes a cloud platform 3, an initial platform 4, and a target platform 5. The initial platform 4 and the target platform 5 are connected to the cloud platform 3. The initial platform 4 is connected to the cloud platform 3 through a first communication connection (e.g., a first local area network or a first BLUETOOTH), and the target platform 5 is connected to the cloud platform 3 through a second communication connection (e.g., a second local area network or a second BLUETOOTH). The first communication connection is different from the second communication connection.

FIG. 2 is a block diagram of an original platform in one embodiment of the present disclosure.

In a current method, a receiver device is preset, data is selected by an input device (such as a mouse) from different platforms, and the selected data is transmitted to the receiver device and then to another platform. The current method is inefficient.

In one embodiment, the initial platform 4 may be an input device (e.g., a mouse or a keyboard) including a first operating system. The initial platform 4 includes a storage device 41 and at least one processor 42. Those skilled in the art will understand that the block diagram is only an example of the initial platform 4, and does not constitute a limitation on the initial platform 4. Other examples of the initial platform 4 may include more or fewer components than shown in FIG. 2, or combine some components, or have different components.

The initial platform 4 can be connected to an external display device (e.g., the initial platform 4 is connected to a display screen through a high-definition multimedia interface), so as to provide a user with a visual interface. The initial platform 4 includes an initial storage area 411 and an initial temporary storage area 412. The initial storage area 411 stores target data (e.g., pictures, texts, documents, etc.). In the embodiment, the initial platform 4 stores the target data in a first designated location of the initial storage area 411. The initial platform 4 also includes a third designated location. The third designated location may be a location where a pre-created document or folder stored in the initial storage area 411 is located, and the third designated location may also be used for storing the target data. The first designated location is different from the third designated location.

In some embodiments, the initial platform 4 can include, but is not limited to, a microprocessor, an application-specific integrated circuits (ASIC), a programmable gate array (FPGA), a digital processor (DSP), an embedded device, etc.

It should be noted that the initial platform 4 in FIG. 2 is only an example. The initial platform 4 can be another electronic device in other embodiments.

In some embodiments, the storage device 41 is used to store program codes and various data, such as the first operating system. The storage device 41 include the initial storage area 411 and the initial temporary storage area 412. The storage device 41 accesses programs or data during operations of the initial platform 4. The storage device 41 can include read-only memory (ROM), programmable read-only memory (PROM), erasable programmable read-only memory (EPROM), one-time programmable read-only memory (OTPROM), electronically-erasable programmable read-only memory (EEPROM), compact disc read-only memory (CD-ROM) or other optical disk storage, magnetic disk storage, tape storage, or any other computer-readable storage medium that can be used to carry or store data.

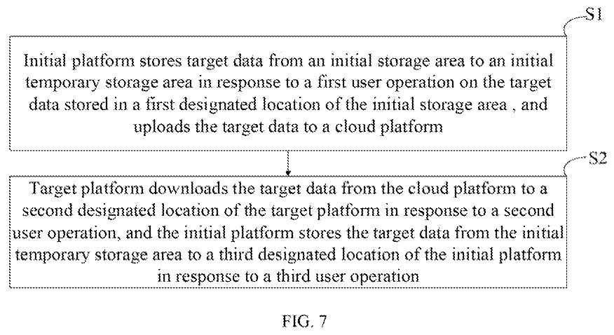

In one embodiment, the storage device 41 stores one or more instructions (i.e., at least one instruction), and the at least one instruction is executed by the at least one processor 42 to implement the data transmission method shown in FIG. 7.

In some embodiments, the at least one processor 42 may be composed of a single integrated circuit or multiple integrated circuits. The integrated circuit is composed of one or more central processing units (CPU), microprocessors, digital processing chips, graphics processors, and various control chips. The processor 42 is a control core of the initial platform 4, which uses various interfaces and lines to connect various components of the initial platform 4, and runs or executes programs stored in the storage device 41, and calls up data stored in the storage device 41 to perform various functions of the initial platform 4 and process data, for example, perform the function of data transmission shown in FIG. 7.

Although not shown, the initial platform 4 may also include a first power source (such as a battery) for supplying power to various components of the initial platform 4. The first power source may be connected to the processor 42 through a first power management device, so as to realize functions such as charging, discharging, and power consumption management. The initial platform 4 may also include other components, such as BLUETOOTH modules.

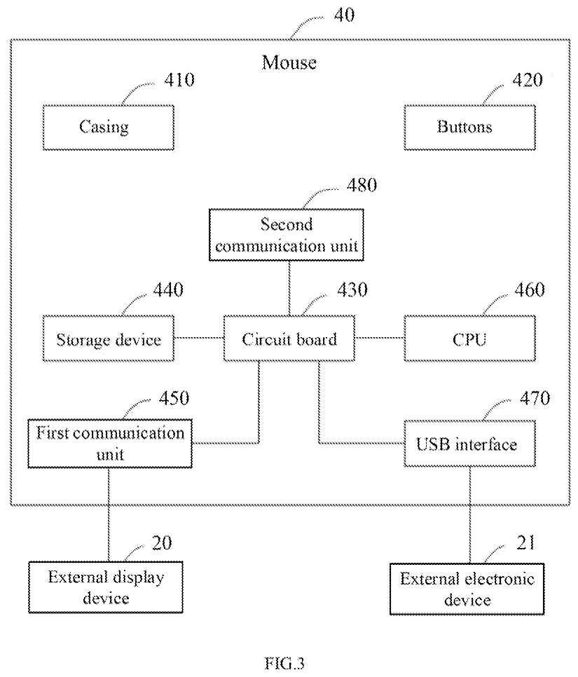

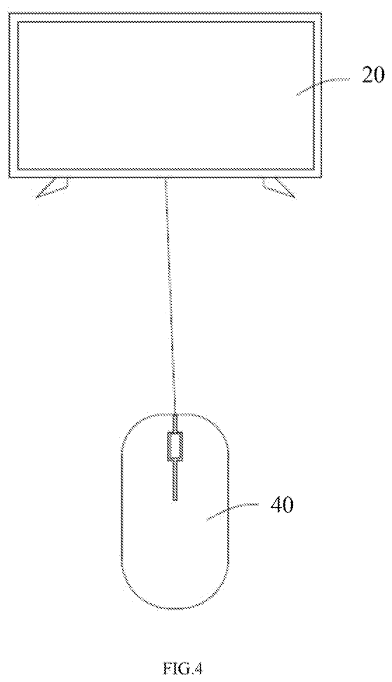

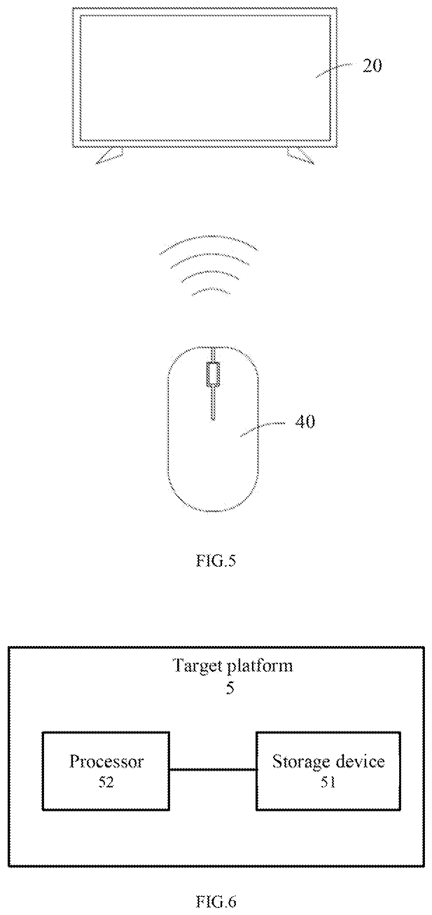

The initial platform 4 may be an input device including a first operating system. FIGS. 3 to 5 show that the initial platform 4 is a mouse. FIG. 3 is a block diagram of a mouse in one embodiment of the present application. FIG. 4 shows a wired connection between a mouse and an external display device in one embodiment of the present disclosure. FIG. 5 shows a wireless connection between a mouse and an external display device in one embodiment of the present disclosure.

Referring to FIG. 3, the mouse 40 includes a casing 410, buttons 420, a circuit board 430, a storage device 440, a first communication unit 450, and a central processing unit 460 (CPU, corresponding to the processor 42 of the initial platform 4). The buttons 420 are arranged on the casing 410. The circuit board 430 is arranged in the casing 410. The storage device 440 is electrically connected to the circuit board 430, and the storage device 440 stores the first operating system and a preset document (e.g., the target data).

It should be noted that the storage device 440 of the mouse 40 is equivalent to the storage device 41 of the initial platform 4. The storage device 440 may include the initial storage area 411 and the initial temporary storage area 412, and the initial storage area 411 stores the target data (e.g., pictures, texts, documents, etc.). In the embodiment, the mouse 40 stores the target data in a first designated location of the initial storage area 411. The mouse 40 also includes a third designated location. The third designated location may be a location where a pre-created document or folder stored in the initial storage area 411 is located, and the third designated location may also be used for storing the target data. The first designated location is different from the third designated location.

The first communication unit 450 is electrically connected to the circuit board 430. The first communication unit 450 is used for communication between the mouse 40 and an external display device 20. The central processing unit 460 is electrically connected to the circuit board 430. The central processing unit 460 generates a startup signal when a first preset condition is satisfied, runs the first operating system and opens the preset document according to the startup signal, and through the first communication unit 450, sends the preset document to the external display device 20 for display. In the embodiment, the circuit board 430, the storage device 440, the first communication unit 450, and the central processing unit 460 are arranged in the casing 410. The first operating system can be microcomputer architecture, and perform some functions of a standard computer system.

The first preset condition may be that the mouse 40 is connected to the external display device 20 through the first communication unit 450. Referring to FIG. 4, the first communication unit 450 may be a high-definition multimedia interface (HDMI), and the first preset condition includes the mouse 40 is wiredly connected to the external display device 20 through the HDMI. Specifically, the first preset condition includes the mouse 40 being connected to the external display device 20 through the HDMI and an HDMI cable.

The first communication unit 450 may be a communication unit in a wireless local area network. The storage device 440 can store a screen projection software, and the first preset condition may be performing a first preset operation on the buttons 420, causing the mouse 40 to be wirelessly connected to the external display device 20 through the screen projection software and the wireless local area network communication unit. Specifically, the wireless local area network communication unit is a WIFI unit, a BLUETOOTH unit, a ZIGBEE unit, or a Narrow Band Internet Of Things (NB-IoT) unit or the like. In the embodiment, the first preset operation on the buttons 420 includes an operation on at least one of the buttons 420, such as pressing a first button and a third button of the mouse 40.

The first preset condition may include performing a second preset operation on the buttons 420. The second preset operation may be the same or different from the first preset operation. The second preset operation and the first preset operation can be operations (same operations or different operations) on different buttons of the mouse 40. For example, the first preset operation is an operation on the first button of the mouse 40, and the second preset operation is an operation on a second button and the third button of the mouse 40. In another embodiment, the second preset operation and the first preset operation are different operations on a same button of the mouse 40. For example, the first preset operation is a pressing operation on the first button of the mouse 40, and the second preset operation is a scrolling operation on the first button of the mouse 40.

The central processing unit 460 further detects the first preset operation or the second preset operation on the buttons 420, and determines whether the first preset operation or the second preset operation is performed for a first time. If the first preset operation or the second preset operation is performed for the first time, the central processing unit 460 generates a startup signal. If the first preset operation or the second preset operation is not performed for the first time, the central processing unit 460 generates a control signal, and through the first communication unit 450, controls the external display device 20 to display the preset document according to the control signal. The central processing unit 460 may control the external display device 20 to scroll page up and/or page down of the preset document.

The mouse 40 further includes a USB interface 470. The USB interface 470 is electrically connected to the circuit board 430. The USB interface 470 connects the mouse 40 with the external electronic device 21, so that the external electronic device 21 is able to obtain the preset document from the external electronic device 21. The USB interface 470 is arranged in the casing 410. The external electronic device 21 can be a computer, a mobile phone, or the like.

The central processing unit 460 further generates an operation signal when a second preset condition is satisfied, runs the first operating system according to the operation signal, and transmits the first operating system to the external display device 20 for display. Therefore, a visual interface is provided. The second preset condition includes a third preset operation on the buttons 420. The third preset operation is different from the second preset operation and the first preset operation. The first preset operation, the second preset operation, and the third preset operation may be operations on different buttons of the mouse 40, or may be different operations on a same button of the mouse 40. Therefore, the mouse 40 can display the first operating system on the external display device 20, and operate the first operating system through the mouse 40.

The central processing unit 460 also communicates with an external cloud platform (e.g., the cloud platform 3) to improve a computing capability of the first operating system on the mouse 40. Specifically, the mouse 40 further includes a second communication unit 480. The second communication unit 480 enables the mouse 40 to communicate with the external cloud platform. The second communication unit 480 includes a wired communication unit. If the first communication unit does not include a WIFI unit, the second communication unit 480 may include a WIFI unit. The central processing unit 460 further connects with the external cloud platform through the wired communication unit or the WIFI unit to improve the computing capability of the first operating system on the mouse 40.

In some embodiment, the first preset operation and the second preset operation, may be different from the third preset operation. For example, the first preset operation and the second preset operation are operations on a left button and a right button of the mouse 40, and the third preset operation is an operation on the left button or the right button of the mouse 40. In this case, it is not necessary to determine whether the first preset operation or the second preset operation is performed for the first time, and the central processing unit 460 further generates the control signal operation according to the third preset operation, and controls the external display device 20 to display the preset document through the first communication unit 450 according to the control signal.

In one embodiment, the mouse 40 stores the first operating system and the preset file. When the operation on the mouse 40 satisfies the first preset condition, the first operating system is run and the preset document is opened. The preset document is transmitted to the external display device 20 for display. When the operation of the mouse 40 satisfies another preset condition (for example, the left button of the mouse 40 selected and the right button of the mouse 40 used to copy and paste), the first operating system is run, and the external display device 20 displays the first operating system. Other operations (e.g., selection operation, copy operation, paste operation, etc.) can be performed to the preset document. The mouse 40 can realize operations of the preset document (for example, display, selection, etc.). FIG. 6 shows a target platform in one embodiment of the present disclosure.

In one embodiment, the target platform 5 may be a storage device including a second operating system. The first operating system and the second operating system can be the same or different. The target platform 5 includes a storage device 51 and at least one processor 52. Those skilled in the art will understand that the block diagram is only an example of the target platform 5, and does not constitute a limitation on the target platform 5. Other examples of the target platform 5 may include more or fewer components than shown in FIG. 6, or combine some components, or have different components.

In some embodiments, the target platform 5 includes, but is not limited to, a microprocessor, an application-specific integrated circuits (ASIC), a programmable gate array (FPGA), a digital processor (DSP), an embedded device, etc.

It should be noted that the target platform 5 in FIG. 6 is only an example. The target platform 5 can be another electronic device in other embodiments.

In some embodiments, the storage device 51 is used to store program codes and various data, such as the second operating system. The storage device 51 can access programs and data during operations of the target platform 5. The storage device 51 can include read-only memory (ROM), programmable read-only memory (PROM), erasable programmable read-only memory (EPROM), one-time programmable read-only memory (OTPROM), electronically-erasable programmable read-only memory (EEPROM), compact disc read-only memory (CD-ROM) or other optical disk storage, magnetic disk storage, tape storage, or any other computer-readable storage medium that can be used to carry or store data.

In one embodiment, the storage device 51 stores one or more instructions (i.e., at least one instruction), and the at least one instruction is executed by the at least one processor 52 to implement the data transmission method shown in FIG. 7.

In some embodiments, the at least one processor 52 may be composed of a single integrated circuit or multiple integrated circuits. The integrated circuit is composed of one or more central processing units (CPU), microprocessors, digital processing chips, graphics processors, and various control chips. The processor 52 is a control core of the initial platform 5, which uses various interfaces and lines to connect various components of the target platform 5, and runs or executes programs stored in the storage device 51, and calls up data stored in the storage device 51 to perform various functions of the target platform 5 and process data, for example, perform the function of data transmission shown in FIG. 7.

Although not shown, the target platform 5 may also include a first power source (such as a battery) for supplying power to various components of the target platform 5. The first power source may be connected to the processor 52 through a first power management device, so as to realize functions such as charging, discharging, and power consumption management. The target platform 5 may also include other components, such as BLUETOOTH modules.

In one embodiment, the target platform 5 includes a second designated location. The second designated location may be a location where a pre-created document or folder stored in the storage device 51 is located.

In one embodiment, the cloud platform 3 may be a software platform applying virtualization. The cloud platform 3 includes a cloud temporary storage area. The cloud temporary storage area is used for storing the target data.

FIG. 7 is a flowchart of the data transmission method in one embodiment of the present disclosure. According to different requirements, the order of the steps in the flowchart may be changed, and some steps may be omitted.

In block S1, the initial platform 4 stores target data from the initial storage area 411 to the initial temporary storage area 412 in response to a first user operation on the target data stored in a first designated location of the initial storage area 411, and uploads the target data to the cloud platform 3. The cloud platform 3 stores the target data uploaded by the initial platform 4.

In one embodiment, the first user operation includes selecting and copying within or all the target data stored in the first designated location. For example, a user uses the left button of the mouse 40 to select the target data, and clicks the right button of the mouse 40 to display a copy option, and uses the left button of the mouse 40 to click the copy option for copying the target data. The cloud platform 3 may store the target data uploaded by the initial platform 4 in a cloud temporary storage area of the cloud platform 3.

In block S2, the target platform 5 downloads the target data from the cloud platform 3 to a second designated location of the target platform 5 in response to a second user operation; and the initial platform 4 stores the target data from the initial temporary storage area 412 to a third designated location of the initial platform 4 in response to a third user operation.

In one embodiment, the second user operation includes pasting the target data to the second designated location, and the third operation includes pasting the target data to the third designated location. For example, the user uses the right button of the mouse 40 to select the third designated location to display a paste option, and uses the left button of the mouse 40 to click the paste option, for pasting the target data. When the target platform 5 detects the second user operation, the target platform 5 downloads the target data from the cloud temporary storage area of the cloud platform 3 to the second designation location of the target platform 5. When the initial platform 4 detects the third operation, the initial platform 4 downloads the target data from the initial temporary storage area 412 to the third designated location of the initial platform 4.

The data transmission system and method use the cloud platform to replace a receiver device for data transmission, improving the efficiency of data transmission between two different platforms. A user can transmit data between the two platforms as if the user was operating in a single platform. The two platforms can each be including different operating systems. The initial platform can be any input device (such as a mouse) with a first operating system. The capabilities of the input device are enhanced.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

In several embodiments provided in the preset application, it should be understood that the disclosed computing device and method may be implemented in other ways. For example, the embodiment of the computing device described above is merely illustrative. For example, the units are only divided and designated according to logical function, and there may be other manners of division in actual implementation.

The modules described as separate components may or may not be physically separated, and the components displayed as modules may or may not be physical modules, that is, may be located in one place, or may be distributed on multiple network elements. Some or all of the modules may be selected according to actual needs to achieve the purpose of the solution of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but do not signify any particular order.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiments can be modified, or some of technical features can be equivalently substituted, and that these modifications or substitutions are not to detract from the essence of the technical solutions or from the scope of the technical solutions of the embodiments of the present disclosure.

We claim:

1. A data transmission system, comprising a cloud platform, an initial platform, and a target platform, the initial platform and the target platform connected to the cloud platform;
the initial platform comprising an initial storage area and an initial temporary storage area, and storing target data at a first designated location of the initial storage area;
the initial platform storing the target data from the initial storage area to the initial temporary storage area in response to a first user operation on the target data stored in the first designated location, and uploading the target data to the cloud platform;
the cloud platform storing the target data uploaded by the initial platform;
the target platform downloading the target data from the cloud platform to a second designated location of the target platform in response to a second user operation; and
the initial platform storing the target data from the initial temporary storage area to a third designated location of the initial platform in responds to a third user operation.

2. The data transmission system of claim 1, wherein the initial platform is an input device comprising a first operating system.

3. The data transmission system of claim 2, wherein the input device comprises:
a casing;
buttons arranged on the casing;
a circuit board arranged in the casing;
a storage device electrically connected to the circuit board and storing the first operating system and a preset document;
a first communication unit electrically connected to the circuit board and used for communication between the input device and an external display device; and
a central processing unit electrically connected to the circuit board, the central processing unit generating a startup signal when a first preset condition is satisfied, running the first operating system and opening the preset document according to the startup signal, and through the first communication unit, sending the preset document to the external display device for display.

4. The data transmission system of claim 3, wherein the central processing unit further generates an operation signal when a second preset condition is satisfied, runs the first operating system according to the operation signal, and transmits the first operating system that is running to the external display device for display.

5. The data transmission system of claim 1, wherein the target platform is a storage device comprising a second operating system.

6. The data transmission system of claim 1, wherein the initial platform is connected to the cloud platform through a first communication connection, and the target platform is connected to the cloud platform through a second communication connection, the first communication connection being different from the second communication connection.

7. The data transmission system of claim 1, wherein the first user operation comprises selecting and copying the target data stored in the first designated location.

8. The data transmission system of claim 1, wherein the cloud platform comprises a cloud temporary storage area for storing the target data.

9. The data transmission system of claim 1, wherein the second user operation comprises pasting the target data to the second designated location; and
the third operation comprises pasting the target data to the third designated location.

10. A data transmission method, comprising:
storing, by an initial platform, target data from an initial storage area of the initial platform to an initial temporary storage area of the initial platform in response to a first user operation on the target data stored in a first designated location of the initial storage area, and uploading the target data to a cloud platform;
storing, by the cloud platform, the target data uploaded by the initial platform;
downloading, by a target platform, the target data from the cloud platform to a second designated location of the target platform in response to a second user operation; and
storing, by the initial platform, the target data from the initial temporary storage area to a third designated location of the initial platform in responds to a third user operation.

11. The data transmission method of claim 10, wherein the initial platform is an input device comprising a first operating system.

12. The data transmission method of claim 11, wherein the input device comprises:
a casing;
buttons arranged on the casing;
a circuit board arranged in the casing;
a storage device electrically connected to the circuit board and storing the first operating system and a preset document;
a first communication unit electrically connected to the circuit board and used for communication between the input device and an external display device; and
a central processing unit electrically connected to the circuit board, the central processing unit generating a startup signal when a first preset condition is satisfied, running the first operating system and opening the preset document according to the startup signal, and through the first communication unit, sending the preset document to the external display device for display.

13. The data transmission method of claim 12, wherein the central processing unit further generates an operation signal when a second preset condition is satisfied, runs the first operating system according to the operation signal, and transmits the first operating system that is running to the external display device for display.

14. The data transmission method of claim 10, wherein the target platform is a storage device comprising a second operating system.

15. The data transmission method of claim 10, wherein the initial platform is connected to the cloud platform through a first communication connection, and the target platform is connected to the cloud platform through a second communication connection, the first communication connection being different from the second communication connection.

16. The data transmission method of claim 10, wherein the first user operation comprises selecting and copying the target data stored in the first designated location.

17. The data transmission method of claim 10, wherein the cloud platform comprises a cloud temporary storage area for storing the target data.

18. The data transmission method of claim 10, wherein the second user operation comprises pasting the target data to the second designated location; and
the third operation comprises pasting the target data to the third designated location.
